(19) United States
(12) Patent Application Publication
(10) Pub. No.: US 2016/0066740 A1
(43) Pub. Date: Mar. 10, 2016

(54) Paper filter

(71) Applicant: Christian Tremblay, Trois-Rivieres (CA)

(72) Inventor: Christian Tremblay, Trois-Rivieres (CA)

(21) Appl. No.: 14/756,370

(22) Filed: Sep. 3, 2015

(30) Foreign Application Priority Data
Sep. 9, 2014 (CA) 2863746

(51) Int. Cl. A47J 31/08; B65D 85/62; B01D 27/06

(52) U.S. Cl. CPC A47J 31/08; B01D 27/06; B65D 85/62

(57) ABSTRACT

A filter paper for a brewing apparatus such as coffee machines, the filter paper comprising a base and a side wall extending upwardly therefrom, the side wall having a top edge, the major portion of the top edge having a scalloped uniform configuration, the minor portion having a height different from the major portion of the top edge. In a preferred embodiment, a pleated arrangement is used wherein the pleats will provide an area which can easily be grasped by the user to separate one filter from another.

### FIELD OF THE INVENTION

The present invention relates to filters and more particularly, relates to paper filters for beverage brewing apparati.

### BACKGROUND OF THE INVENTION

Paper filters are commonly used in beverage brewing apparati and in particular, they are widely used in coffee brewing machines. Although there have been suggestions that permanent filters may be used, it is still a common practice to use paper filters which are supported within the coffee brewer. Paper filters remove some oily components such as ditherenes which are present in unfiltered coffee. Metal or nylon mesh filters do not remove these components.

Paper coffee filters are generally made from about 100 g/m squared crepe paper the creping allows the coffee to flow freely between the filter and the filtration tunnel. The pulp for the filter paper comprises coarse long fibres, either bleached or unbleached.

Typically, both basket and cone coffee filters are sold as a plurality of filters nesting one within the other. These filters are packaged for use both for typical home use and also for use in commercial establishments such as restaurants and the like. Common to both of these applications is the problem of removing a single filter from the nested filters. This becomes a problem in many commercial establishments since time is of the essence and frequent access to the filters is required.

It is often seen that the person attempting to remove a single filter will stick a finger to their mouth to wet the same. This provides for improved adherence of a single filter to the finger. However, the practice is unsanitary and not approved of.

### SUMMARY OF THE INVENTION

It is an object of the present invention to provide for a paper filter design wherein a single filter may easily be removed from a nested stack of filters.

It is a further object of the present invention to provide a method for the ease of use of dispensing of stacked nested paper filters.

According to one aspect of the present invention, there is provided a filter paper comprising a base, a side wall, the side wall having a top edge, a major portion of the top edge having a scalloped uniform configuration, a minor portion of the top edge having a height different from the major portion of the top edge.

According to a further aspect of the present invention, there is provided a container having a plurality of filter papers therein, the filter papers being nested one within another, each filter paper comprising a base, a side wall, the side wall having a top edge, a major portion of the top edge having a scalloped uniform configuration, a minor portion of the top edge having a height different from the major portion of the top edge.

According to a still further aspect of the present invention, there is provided a method for the easy dispensing of paper filters from a plurality of the filters one nested within another, the method comprising the step of forming the filter paper to have a base, a side wall, the side wall having a top edge, a major portion of the top edge having a scalloped configuration, and a minor portion of the top edge having a non scalloped configuration.

The paper filter of the present invention is formed in a conventional manner. However, the difference is to provide a top edge which is of a different height from the height of the major portion of the filter.

The filter paper of the present invention will utilize paper which is known in the art. As previously stated, such filter papers are conventionally formed of a crepe paper. The filter paper is generally fluted and has a scalloped top edge.

In a preferred embodiment of the present invention, at least one pleat is provided in the side wall of the paper filter. This pleated portion will provide a grip for the fingers of the user.

Preferably, there will be a pair of pleats formed in the side wall, each of the pleats being diametrically opposed to the other.

The present invention may be practised with different arrangements of filter papers including those which have a basket configuration and those which have a conical configuration. Both are known in the art and are designed for different types of machines.

### BRIEF DESCRIPTION OF THE DRAWINGS

Having thus generally described the invention, reference will be made to the accompanying drawings illustrating embodiments thereof, in which:

FIG. 1 is a perspective view of a filter according to one embodiment of the present invention;

FIG. 2 is a perspective view of a further embodiment of a filter according to the present invention;

FIG. 3 is a plan view of the filter of FIG. 2 prior to forming of the same;

FIG. 4 is a perspective view of a further embodiment of a filter according to the present invention;

FIG. 5 is a perspective view of a further embodiment of a filter according to the present invention;

FIG. 6 is a perspective view of an embodiment similar to that illustrated in FIG. 1;

FIG. 7 is a perspective view illustrating a conical filter; and

FIG. 8 illustrates the removal of a single filter from a nested group of filters.

### DETAILED DESCRIPTION OF THE INVENTION

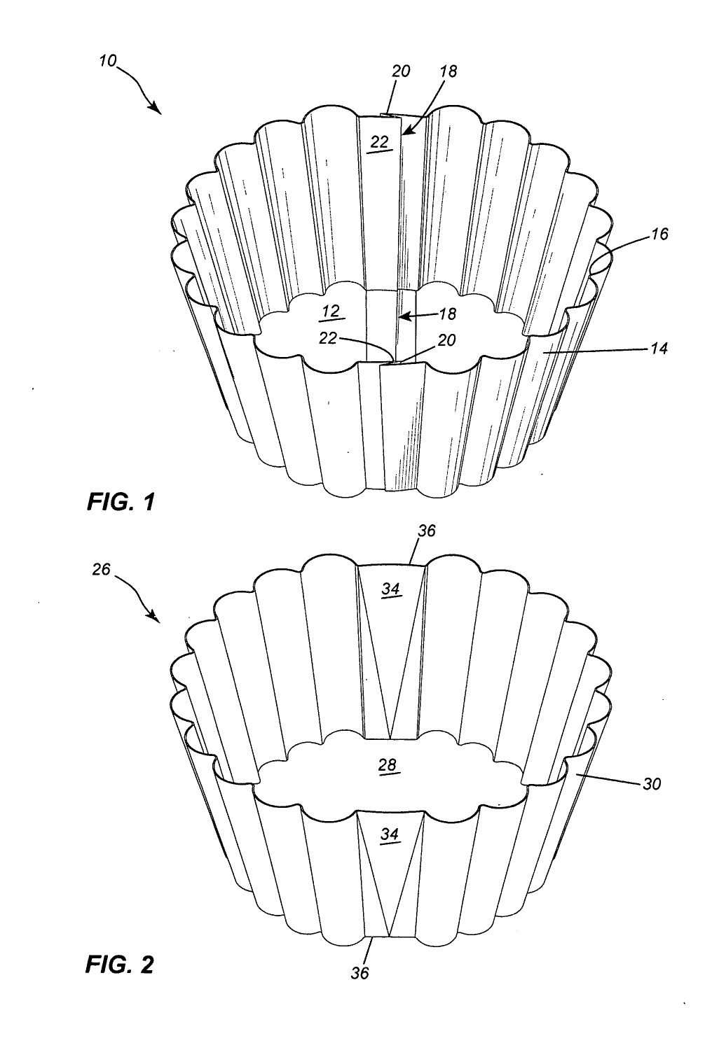

Referring to the drawings in greater detail and by reference characters thereto, there is illustrated in FIG. 1 a paper filter of the truncated cone variety as is typically used in filtering beverages such as coffee and the like, generally designated by reference numeral 10. Paper filter 10 has a bottom wall 12 and a side wall 14. Side wall 14 includes scalloped upper edge 16.

Extending diametrically across paper filter 10 is a pleat generally designated by reference numeral 18. Pleat 18 is folded upon itself and thus has a folded back portion 20 which lies adjacent side wall 14. Pleat 18 will also have an outer layer 22 which continues along to form side wall 14.

In use, the user may raise pleat 18 either along the side wall or the bottom wall by inserting a finger nail underneath. Pleat 18 then gives a place to pull the filter from other filters with which it is stacked.

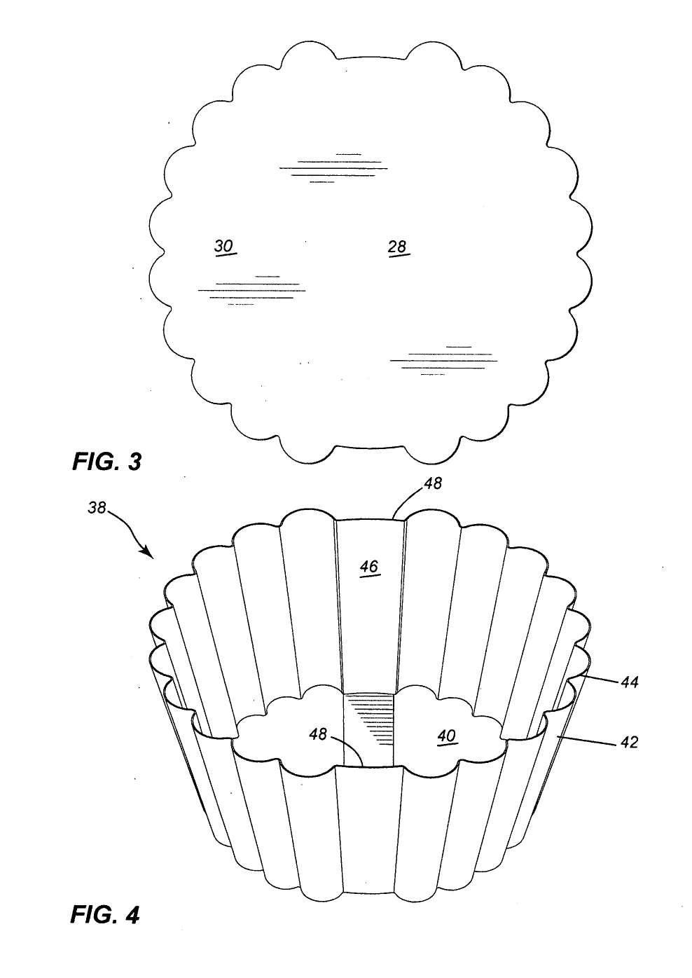

In the embodiment of FIGS. 2 and 3, a paper filter 26 also has a bottom wall 28 and a side wall 30. Formed within side wall 30 is a triangular portion 34 which has a flat upper edge 36. This provides a portion to grasp the filter more easily than would otherwise be provided.

In the embodiment of FIG. 4, a paper filter 38 likewise has a bottom wall 40 and a side wall 42 with a scalloped edge 44. There is, in this embodiment, a central portion 46 which has a flat edge 48. Flat edge 48 will assist in the removal of paper filter 38 from a stack of the same.

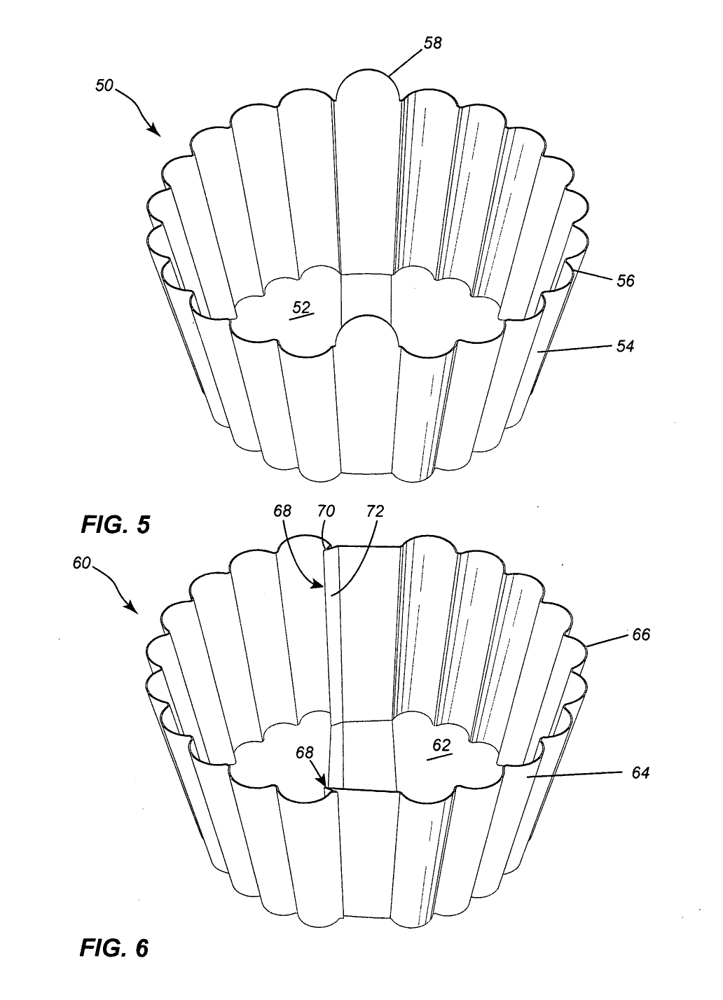

In the embodiment of FIG. 5, there is provided a paper filter generally designated by reference numeral 50. Paper filter 50 has a bottom wall 52 and a side wall 54. Side wall 54 has a scalloped upper edge 56. This embodiment includes an upwardly extending tab portion 58 which will provide for easier gripping such that one may more easily remove a single filter from a stack of the same.

In the embodiment of FIG. 6, there is provided a filter generally designated by reference numeral 60. As was the case with the embodiment of FIG. 1, filter 60 has a base 62 and a side wall 64. A scalloped top edge 66 is provided. In this embodiment, there is also provided a pair of pleats 68. Pleat 68 is folded upon itself and thus has a folded back portion 70 which lies adjacent wall 64.

The pleat is formed in the paper prior to the cutting and forming of the filter.

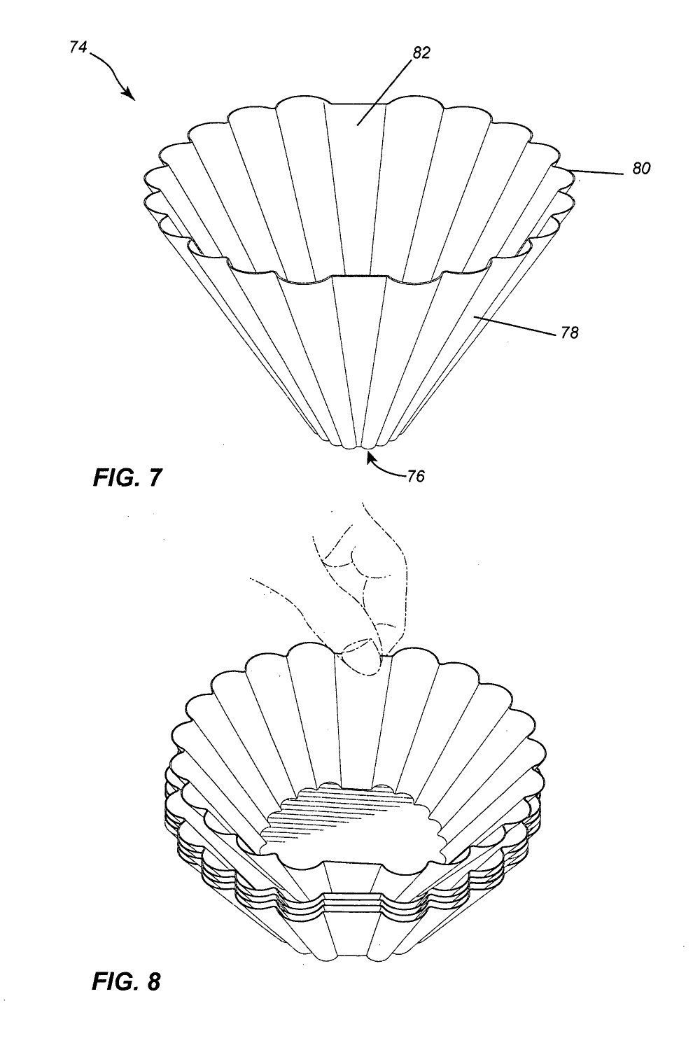

The embodiment of FIG. 7 illustrates a conical filter generally designated by reference numeral 74. Conical filter 74 has a base 76, a side wall 78 and a scalloped top edge 80. A straight wall portion 82 is provided.

As shown in FIG. 8, the provision of the non scalloped edge allows for easier removal of a filter from a stack of the same.

It will be understood that the above described embodiment is for purposes of illustration only and that changes and modifications may be made thereto without departing from the spirit and scope of the invention.

I claim:

1. A filter paper comprising:
a base;
a side wall, said side wall having a top edge, a major portion of said top edge having a scalloped uniform configuration, a minor portion of said top edge having a height different from said major portion of said top edge.

2. The filter paper of claim 1 wherein said minor portion of said top edge has a straight configuration.

3. The filter paper of claim 1 wherein said minor portion comprises a pair of minor portions, each of said minor portions being diametrically opposed.

4. The filter paper of claim 3 wherein said side wall is fluted.

5. The filter paper of claim 4 wherein said filter paper is crepe paper.

6. The filter paper of claim 3 wherein at least one of said minor portions has a pleat formed therein.

7. The filter paper of claim 6 wherein both of said minor portions have a pleat formed therein.

8. The filter paper of claim 7 wherein said filter paper has a basket configuration.

9. The filter paper of claim 7 wherein said filter paper has a conical configuration.

10. A container having a plurality of filter papers therein, said filter papers being nested one within another, each filter paper comprising:
a base;
a side wall, said side wall having a top edge, a major portion of said top edge having a scalloped uniform configuration, a minor portion of said top edge having a height different from said major portion of said top edge.

11. The filter paper of claim 10 wherein said minor portion of said top edge has a straight configuration.

12. The filter paper of claim 10 wherein said minor portion comprises a pair of minor portions, each of said minor portions being diametrically opposed.

13. The filter paper of claim 12 wherein said side wall is fluted.

14. The filter paper of claim 13 wherein said filter paper is crepe paper.

15. The filter paper of claim 12 wherein at least one of said minor portions has a pleat formed therein.

16. The filter paper of claim 15 wherein both of said minor portions have a pleat formed therein.

17. The filter paper of claim 16 wherein said filter paper has a basket configuration.

18. The filter paper of claim 17 wherein said filter paper has a conical configuration.

19. A method for the easy dispensing of paper filters from a plurality of said filters one nested within another, the method comprising the step of forming said filter paper to have a base, a side wall, said side wall having a top edge, a major portion of said top edge having a scalloped configuration, and a minor portion of said top edge having a non scalloped configuration.

20. The method of claim 19 wherein the step of forming said filter paper such that a minor portion of said top edge has a non scalloped configuration comprises forming a pleat in said minor portion.
